(19) United States
(12) Patent Application Publication
(10) Pub. No.: US 2005/0170102 A1
(43) Pub. Date: Aug. 4, 2005

(54) Method for manufacturing semiconductor device

(75) Inventors: Isao Matsumoto, Kyoto (JP); Naofumi Ohashi, Tokyo (JP); Kaori Misawa, Gifu (JP); Shuji Sone, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Semiconductor Leading Edge Technologies, Inc., Tsukuba-shi (JP)

(21) Appl. No.: 11/036,138

(22) Filed: Jan. 18, 2005

(30) Foreign Application Priority Data
Jan. 29, 2004 (JP) 2004-021341

(51) Int. Cl. H05H 1/00

(52) U.S. Cl. 427/535

(57) ABSTRACT

A method for manufacturing a semiconductor device comprises: exposing a surface of a substrate to plasma; and forming an insulating film containing a low dielectric constant material on the surface of the substrate. A method for manufacturing a semiconductor device comprises: forming a modified layer by exposing a surface of a substrate to plasma; and forming an insulating film containing a low dielectric constant material on the modified layer. A method for manufacturing a semiconductor device comprises: forming an adhesion enhancement layer on a substrate; exposing a surface of the adhesion enhancement layer to plasma; and forming a first insulating film on the adhesion enhancement layer.

### CROSS-REFERENCE TO RELATED APPLICATIONS

This application is based upon and claims the benefit of priority from the prior Japanese Patent Application No. 2004-021341, filed on Jan. 29, 2004; the entire contents of which are incorporated herein by reference.

### BACKGROUND OF THE INVENTION

The invention relates to a method for manufacturing a semiconductor device, and more particularly, to a method for manufacturing a semiconductor device with an interlayer insulating structure using low dielectric constant insulating film and a method of manufacturing the same.

Metallic wiring in a semiconductor integrated circuit has encountered a significant problem of signal delay due to the increase of wiring resistance and interwiring capacitance as the wiring pitch decreases. To solve this, the reduction of dielectric constant of the interlayer isolation film provided between the wirings is indispensable (see, e.g., Japanese Laid-Open Patent Application H11-97533 (1999)). For example, the effective relative dielectric constant required for interlayer insulating film compliant with the next-generation 65-nanometer technology node is supposed to be 2.2 to 2.7.

However, since the low dielectric constant (low-k) film is formed as porous material in many cases, a mechanical strength of the film becomes poor and, also, adhesiveness between an upper layer and an underlying layer tends to be deteriorated.

This problem provokes a fall of reliability due to film peeling and moisture penetration at interfaces in subsequent processes.

Moreover, void may be generated along interfaces inside the film due to low adhesiveness in the low dielectric constant film having porosities.

The structure in which an adhesion enhancement layer is provided between the low dielectric constant film and the underlying layer to improve adhesiveness has been proposed. However, the adhesiveness can not be improved sufficiently by above structure.

### SUMMARY OF THE INVENTION

According to an embodiment of the invention, there is provided a method for manufacturing a semiconductor device comprising: exposing a surface of a substrate to plasma; and forming an insulating film containing a low dielectric constant material on the surface of the substrate.

According to other embodiment of the invention, there is provided a method for manufacturing a semiconductor device comprising: forming a modified layer by exposing a surface of a substrate to plasma; and forming an insulating film containing a low dielectric constant material on the modified layer.

According to other embodiment of the invention, there is provided a method for manufacturing a semiconductor device comprising: forming an adhesion enhancement layer on a substrate; exposing a surface of the adhesion enhancement layer to plasma; and forming a first insulating film on the adhesion enhancement layer.

Note that the term “low dielectric constant material” as used in this specification means materials having relative dielectric constants lower than that of conventional silicon oxide (SiO₂), and more specifically, means materials having relative dielectric constants lower than 4.

### BRIEF DESCRIPTION OF THE DRAWINGS

The present invention will be understood more fully from the detailed description given here below and from the accompanying drawings of the embodiments of the invention. However, the drawings are not intended to imply limitation of the invention to a specific embodiment, but are for explanation and understanding only.

In the drawings:

FIG. 1 is a flow chart showing the method for manufacturing a semiconductor device according to the present embodiment;

FIGS. 2A through 2D are cross-sectional views showing manufacturing steps of a principal part of the manufacturing method according to the present embodiment;

FIG. 3 is a flow chart showing the method for manufacturing a semiconductor device according to the modification of the present embodiment;

FIGS. 4A through 4C are cross-sectional views showing manufacturing steps of a principal part of the manufacturing method according to the modification of the embodiment;

FIGS. 5A through 5C are process cross-sectional views showing manufacturing steps of a principal part of the manufacturing method according to the modification of the embodiment;

FIGS. 6A through 6B are process cross-sectional views showing manufacturing steps of a principal part of the manufacturing method according to the modification of the embodiment; and

FIG. 7 is a schematic view illustrating a cross-sectional structure of a principal part of a semiconductor device manufactured according to the invention.

### DETAILED DESCRIPTION

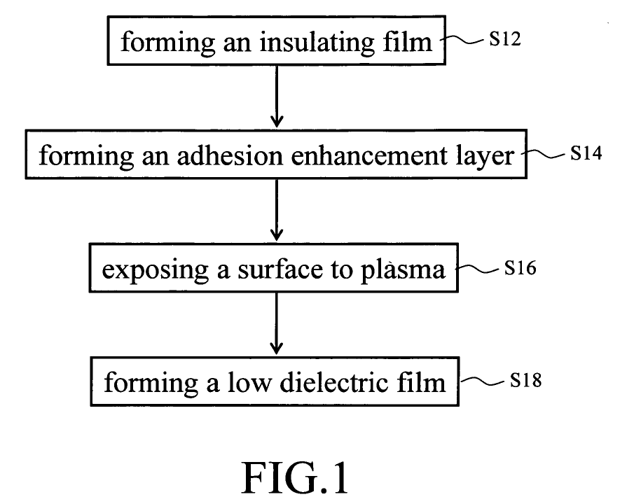

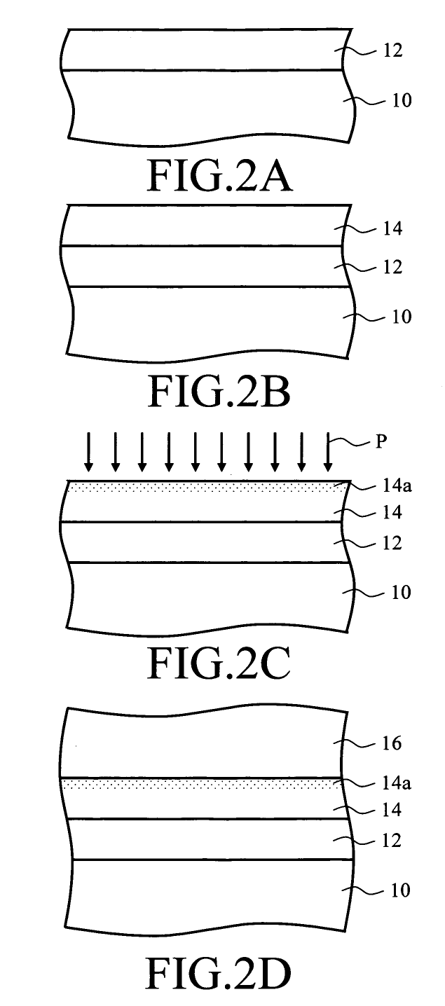

Referring to drawings, some embodiments of the present invention will now be described in detail. FIG. 1 is a flow chart showing the method for manufacturing a semiconductor device according to the present embodiment. FIGS. 2A through 2D are process cross-sectional views showing a principal part of the manufacturing method according to the present embodiment.

First, as shown in FIG. 1 (step S12) and FIG. 2A, an insulating film 12 is formed on a substrate 10. A semiconductor substrate on which a predetermined semiconductor element is formed can be used as the substrate 10, for example, as explained later in detail referring to an example.

The insulating film 12 can be made of materials appropriately selected according to various uses, such as a low dielectric constant film, an etching stopper, a buffer layer, and a hard mask. For example, when the insulating film 12 is used as the etching stopper, the insulating film 12 maybe made of the thin film including silicon nitride (SiNx), silicon carbide (SiCx), silicon carboxide (SiCxOy), silicon oxinitride (SiOₓN_{y}), silicon carbonitride (SiCxNy) or the like. When providing the insulating film 12 as the low dielectric constant film, the insulating film 12 may be made of materials including silicon oxides having methyl group(s), silicon oxides having hydrogen group(s), and organic polymers. Such materials may include, for example, various silsesquioxane compounds, polyimide, fluorocarbon, parylene, and benzocyclobutene.

Silicon oxide (SiOx) can also be used as the underlying film which constitutes the insulating film 12. The insulating film 12 doesn't necessarily have to be provided, but may be omitted, in the embodiment of the invention.

Next, as shown in FIG. 1 (step S14) and FIG. 2B, the adhesion enhancement layer 14 is formed. The adhesion enhancement layer 14 has a function of promoting an adhesiveness of the low dielectric constant film formed thereon. In this embodiment, the adhesion enhancement layer 14 is made of a material by which the better adhesiveness can be obtained compared to the structure of the low-k film formed on the insulating film 12. Specifically, the adhesion enhancement layer 14 can be made from the same kind of materials as that of the low dielectric constant film formed thereon, for example. However, it is desirable to vary appropriately film quality, density, porosity containing rate of the material of the adhesion enhancement layer 14. Generally, the material having low density and high porosity rate is used as the low dielectric constant film. However, as the adhesion enhancement layer 14, a material which is made from the same kind of materials as the low dielectric constant film and has a little higher density and a little lower vacancy content can be used. As a material of the adhesion enhancement layer 14, silicon oxides having methyl group(s) can be used, for example.

Subsequently, plasma treatment is applied as shown in FIG. 1 (step S16) and FIG. 2C. Specifically, the plasma P is generated from gas such as helium (He), hydrogen (H₂), nitride oxide (N₂O), and ammonia (NH₃). The surface of the adhesion enhancement layer 14 is exposed to the plasma P. Then, a modified layer 14a is formed on the surface of the adhesion enhancement layer 14. Then the surface of the adhesion enhancement layer 14a becomes rougher, and tends to turn into a hydrophilic surface.

As shown in FIG. 1 (Step S18) and FIG. 2D, the low dielectric constant film 16 is formed on the modified layer 14a. A porous methyl silsequioxane (MSQ) can be used as the low dielectric constant film 16, for example. The method of forming such materials may include the spin on glass (SOG) method in which a thin film is formed by spin coating and heat treating the solution.

The low-k film 16 may be made of materials including silicon oxides having methyl group(s), silicon oxides having hydrogen group(s), and organic polymers. Such materials may include, for example, various silsesquioxane compounds, polyimide, fluorocarbon, parylene, and benzocyclobutene.

According to the embodiment of the invention, the adherability of the low dielectric constant film 16 can be enhanced by applying the plasma treatment in step S16. It is considered that the adhesiveness of the low dielectric constant film 16 is enhanced by anchor effect as a result of forming the modified layer 14a of increased roughness on the surface of the adhesion enhancement layer 14 by plasma treatment. Simultaneously, it is considered that the surface of the modified layer 14a formed by plasma treatment is turned to the hydrophilic surface, and can enhance the adhesiveness to the low-k film formed thereon. Furthermore, it becomes possible to prevent moisture penetration along the interface with the low dielectric constant film 16 by making the surface of the modified layer 14a hydrophilic. As a result, moisture resistance is improved, and then high reliability can be obtained.

According to the embodiment of the invention, the adhesiveness between the low dielectric constant film and the underlying film can be improved. As a result, also in a CMP (chemical mechanical polishing) process in which mechanical stress is applied, the problems, such as film peeling and moisture penetration along the interface, can be avoided.

In addition, it is desirable that the plasma treatment is applied for a time range of b 5-120 seconds in the embodiment of the invention. If the time of the plasma treatment is too short, the modified layer 14a is not formed effectively. On the other hand, if the time of the plasma treatment is too long, problems such as a disappearance of the adhesion enhancement layer 14 due to an excess sputtering may occur.

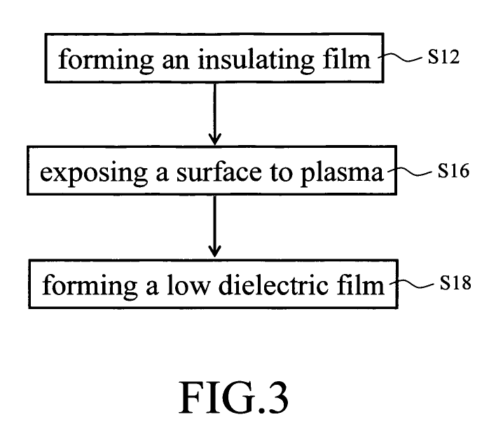

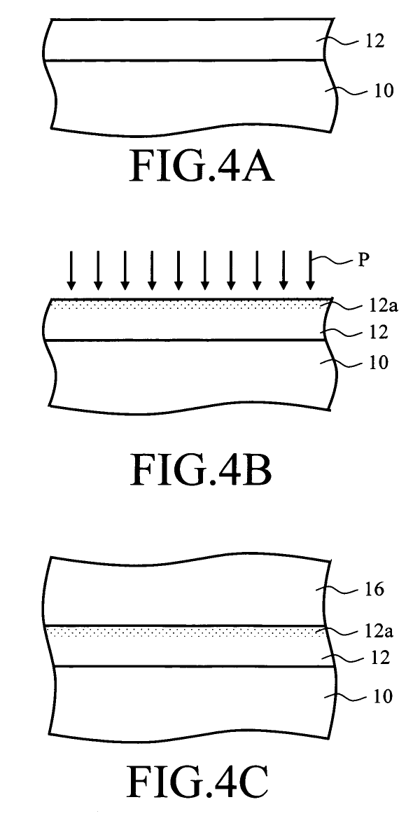

FIG. 3 is a flow chart showing the method for manufacturing a semiconductor device according to the modification. FIGS. 4A through 4C are process cross-sectional views showing a principal part of the manufacturing method according to the present embodiment. The same symbols are given to the same elements as what were mentioned above with references to FIG. 1 through FIG. 2D about these figures, and detailed explanation will be omitted.

In this modification, the modified layer 12a is formed by applying plasma treatment to the surface of the insulating film 12 without forming the adhesion enhancement layer 14. Subsequently, the low dielectric constant film 16 is formed on the property-modified layer 12a. Also in this process, the adherability of the low dielectric constant film 16 can be enhanced.

Hereafter, an example of applying the invention to a manufacturing process of connecting a function element by metal wirings in a manufacturing process of the semiconductor integrated circuit will be explained according to an example of the invention. In this example, metal wiring process in the case of using a material whose dielectric constant is lower than that of a silicon dioxide film as interlayer films will be explained.

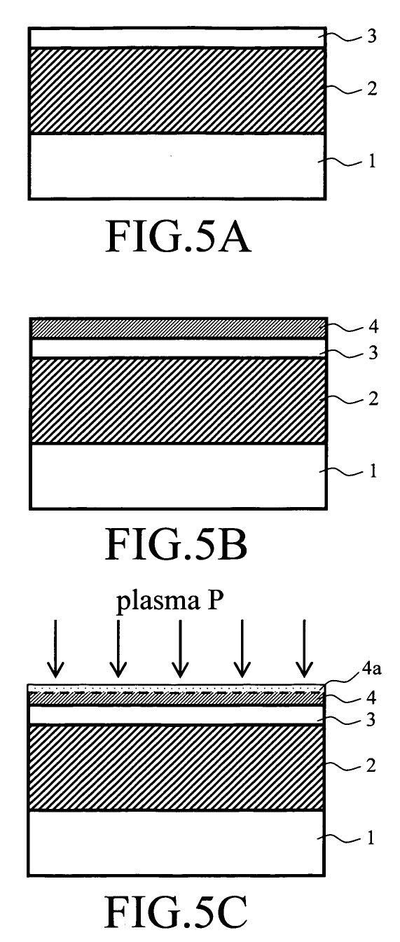

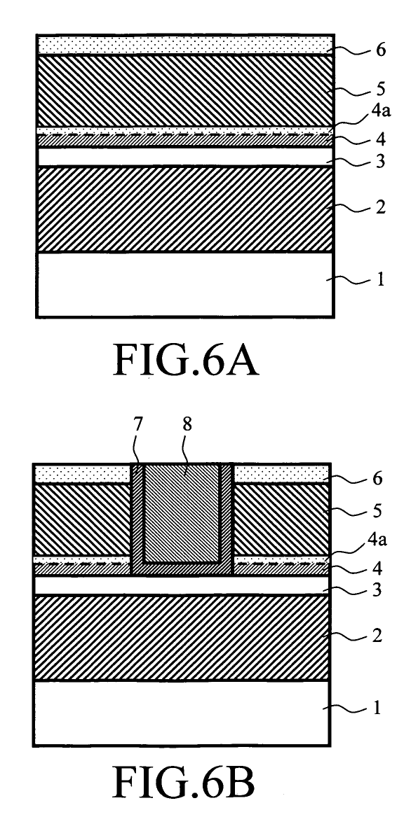

FIGS. 5A through 6B are process cross-sectional views showing a method of manufacturing a semiconductor device according to an example of the invention.

First, as shown in FIG. 5A, a silicon wafer 1 is coated with a silicon oxide film 2 acting as an insulating film to a thickness of 500 nm. The silicon oxide film 2 is coated with an insulating film 3 comprising silicon nitride (SiNx) or silicon carbide (SiCx) having a thickness of about 30 to 50 nm by CVD (chemical vapor deposition) method. The insulating film 3 acts as an etching stopper. More specifically, the insulating film 3 functions to control the etching of a subsequently formed low-k film to prevent the etching from progressing to its underlying layer. For this purpose, it is desirable that the insulating film 3 is formed from material having a lower etching rate than the low-k film by a factor of about 10 to 20.

Next, as shown in FIG. 5B, an adhesion enhancement layer 4 for enhancing adhesiveness to the low-k film that will be subsequently formed thereon is formed to a thickness of about 10 to 50 nm by the coating method. The material for the adhesion enhancement layer 4 in this specific example may include silicon oxides containing methyl group(s). This material is coated at a rotation speed of 500 rpm and cured at a temperature of about 450 degrees Centigrade.

Next, as shown in FIG. 5C, the surface of the adhesion enhancement layer 4 is plasma treated. More specifically, it is exposed to plasma of helium (He) gas, nitrogen oxide (N₂O) gas or hydrogen (H₂) gas under the condition of a power of 1 kW, a pressure of 1 kPa, and a temperature of 400 degrees Centigrade for about 15 to 30 seconds. Then, the modified layer 14a is formed on the surface.

Subsequently, as shown in FIG. 6A, a MSQ film 5 having pores is formed to a thickness of 250 nm by the coating method. Then, the silicon-oxide film 6 is further formed by the CVD method thereon. The low-k film 5 was made of material having a dielectric constant of 2.2 and a Young's modulus of 3 GPa. The low-k film 5 was formed by carrying out coating at a rotation speed of 900 rpm, then baking on the hot plate in N2 atmosphere at a temperature of 250 degrees Centigrade, and finally curing on hot plate at a temperature of 450 degrees Centigrade for 10 minutes.

Subsequently, as shown in FIG. 6B, a metallic wiring is formed. Subsequently, the sputtering method is used to continuously deposit a film stack 7 composed of a tantalum nitride (TaN) film of 10 nm, a tantalum (Ta) film of 15 nm, and a seed copper (Cu) film of 65 nm. Then the electroplating method is used to form a copper film 8 of 500 nm, and the CMP method is used to polish Cu, Ta, and TaN except the groove, thereby forming a metallic wiring in the groove portion.

In addition, in the present example, the surface of the adhesion enhancement layer 4 is exposed to plasma P to form a modified layer, thereby increasing the adhesion strength of the low-k film 5. As a result, the problem of peeling of the low-k film 5 can also be eliminated during the polishing process by the CMP method described above with reference to FIG. 6B.

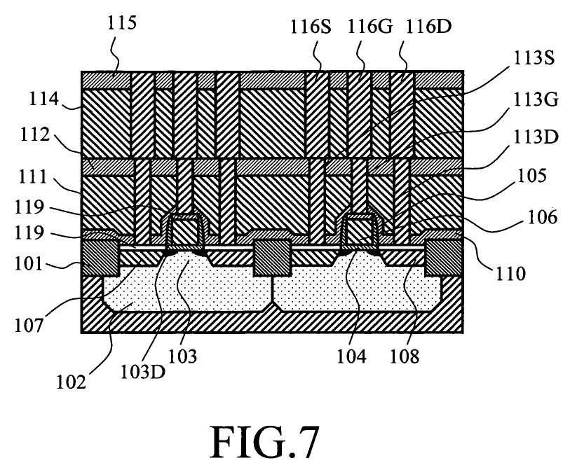

FIG. 7 is a schematic diagram illustrating the cross-sectional structure of the principal part of the semiconductor device manufactured by the manufacturing method of the invention. This figure expresses the cross-sectional structure of the principal part of MOSFET (Metal Oxide Semiconductor Field Effect Transistor) which constitutes a semiconductor integrated circuit.

The surface of the silicon substrate is separated by the isolation region 101 in insulation. MOSFETs are formed in each of the separated wells 102. Each MOSFET has the source region 107, the drain region 108, and the channel 103 provided between these. The gate electrode 106 is provided through the gate insulating film 104 on the channel 103. LDD (lightly doped drain) region 103D is provided to prevent the so-called “short channel effect” among the source region 107, the drain region 108 and the channel 103, for example. The gate side wall 105 is provided adjoining to the gate electrode 106 on the LDD region 103D. The gate side wall 105 is provided in order to form LDD region 103D in self-aligning.

The silicide layer 119 is provided in order to improve contact with electrodes on the source region 107, the drain region 108, and the gate electrode 106. The structure is covered with the first interlayer isolation film 110, the second interlayer isolation film 111, and the third interlayer isolation film 112. The source contact 113S, gate contact 113G, and drain contact 113D are formed through contact holes which penetrate these interlayer isolation films. Here, the first interlayer isolation film 110 and the third interlayer isolation film 112 have a function of the etching stopper, and, for example, can be formed by a silicon nitride. The second interlayer isolation film 111 can be the low dielectric constant film consisting of a porous silicon oxide.

The fourth interlayer isolation film 114 and the fifth interlayer isolation film 115 are further formed thereon. And embedded formation of source wirings 116S, gate wirings 116G, and the drain wirings 116D are formed embedded in the trenches, respectively. The fourth interlayer isolation film 114 can also be the low dielectric constant film consisting of a porous silicon oxide. The fifth interlayer isolation film 115 can be formed by silicon nitride.

At the time of manufacturing the semiconductor device explained above according to the invention, the adhesiveness of the second interlayer isolation film 111 is enhanced by applying plasma treatment to the surface of the first interlayer isolation film 110 prior to the formation of the second interlayer isolation film 111.

Similarly, the adhesiveness of the fourth interlayer isolation film 114 is enhanced by applying plasma treatment to the surface of the third interlayer isolation film 112 prior to the formation of the fourth interlayer isolation film 114.

The modified layer can enhance the adhesiveness of these interlayer isolation films 111 and 114 of the low-k film formed and suppress the problems of film peeling in the CMP process and degradation due to moisture penetration, owing to such plasma treatment.

Heretofore, the embodiments of the present invention have been explained, referring to the examples. However, the present invention is not limited to these specific examples.

For example, any specific structure, size, and material of the semiconductor device, including their variations appropriately modified and adapted by those skilled in the art, are encompassed within the scope of the invention, as long as they include the features of the invention. Any formation method, formation condition, processing condition, etching condition, and heat treatment condition for various layers, not only described above by specific examples, but also their variations appropriately designed by those skilled in the art, are encompassed within the scope of the invention.

Furthermore, any other methods of manufacturing a semiconductor device that comprise the elements of the invention and that may be appropriately modified by those skilled in the art are encompassed within the scope of the invention.

1. A method for manufacturing a semiconductor device comprising:
exposing a surface of a substrate to plasma; and
forming an insulating film containing a low dielectric constant material on the surface of the substrate.

2. The method for manufacturing a semiconductor device according to claim 1, wherein the plasma is formed by using at least one selected from the group consisting of helium (He), hydrogen (H₂), nitrogen oxide (N₂O), and ammonia (NH₃).

3. The method for manufacturing a semiconductor device according to claim 1, wherein the low dielectric constant material includes as a main ingredient at least one selected from the group consisting of silicon oxides having one or more methyl groups, silicon oxides having one or more hydrogen groups, and organic polymers.

4. The method for manufacturing a semiconductor device according to claim 1, wherein an adhesion enhancement layer made of a same kind of material as the low dielectric constant material is formed on the surface of the substrate.

5. The method for manufacturing a semiconductor device according to claim 1, wherein an insulating film made of a different kind of material as the low dielectric constant material is formed on the surface of the substrate.

6. The method for manufacturing a semiconductor device according to claim 5, wherein the different kind of material is one selected from the group consisting of silicon oxide (SiOₓ), silicon nitride (SiNₓ), silicon carbide (SiCₓ), silicon carboxide (SiCₓO_{y}), silicon oxinitride (SiOₓN_{y}), and silicon carbonitride (SiCₓN_{y}).

7. A method for manufacturing a semiconductor device comprising:
forming a modified layer by exposing a surface of a substrate to plasma; and
forming an insulating film containing a low dielectric constant material on the modified layer.

8. The method for manufacturing a semiconductor device according to claim 7, wherein the plasma is formed by using at least one selected from the group consisting of helium (He), hydrogen (H₂), nitrogen oxide (N₂O), and ammonia (NH₃).

9. The method for manufacturing a semiconductor device according to claim 7, wherein the low dielectric constant material comprises as a main ingredient at least one selected from the group consisting of silicon oxides having one or more methyl groups, silicon oxides having one or more hydrogen groups, and organic polymers.

10. The method for manufacturing a semiconductor device according to claim 7, wherein an adhesion enhancement layer made of a same kind of material as the low dielectric constant material is formed on the surface of the substrate.

11. The method for manufacturing a semiconductor device according to claim 7, wherein an insulating film made of a different kind of material as the low dielectric constant material is formed on the surface of the substrate.

12. The method for manufacturing a semiconductor device according to claim 11, wherein the different kind of material as the low dielectric constant material is one selected from the group consisting of silicon oxide (SiOx), silicon nitride (SiNx), silicon carbide (SiCx), silicon carboxide (SiCxOy), silicon oxinitride (SiOₓN_{y}), and silicon carbonitride (SiCₓN_{y}).

13. A method for manufacturing a semiconductor device comprising:
forming an adhesion enhancement layer on a substrate;
exposing a surface of the adhesion enhancement layer to plasma; and
forming a first insulating film on the adhesion enhancement layer.

14. The method for manufacturing a semiconductor device according to claim 13, wherein a second insulating film is formed on a surface of the substrate.

15. The method for manufacturing a semiconductor device according to claim 14, wherein the second insulating film is made of one selected from the group consisting of silicon oxide (SiOx), silicon nitride (SiNx), silicon carbide (SiCx), silicon carboxide (SiCxOy), silicon oxinitride (SiOₓN_{y}), and silicon carbonitride (SiCₓN_{y}).

16. The method for manufacturing a semiconductor device according to claim 13, wherein the adhesion enhancement layer is made of a same kind of material as that of the first insulating film, and a density of the adhesion enhancement layer is higher than that of the first insulating film.

17. The method for manufacturing a semiconductor device according to claim 13, wherein the adhesion enhancement layer is made of a same kind of material as that of the first insulating film, and a dielectric constant of the adhesion enhancement layer is higher than that of the first insulating film.

18. The method for manufacturing a semiconductor device according to claim 13, wherein the first insulating film includes as a main ingredient at least one selected from the group consisting of silicon oxides having one or more methyl groups, silicon oxides having one or more hydrogen groups, and organic polymers.

19. The method for manufacturing a semiconductor device according to claim 13, wherein the plasma is formed by using at least one selected from the group consisting of helium (He), hydrogen (H₂), nitrogen oxide (N₂O), and ammonia (NH₃).

20. The method for manufacturing a semiconductor device according to claim 13, further comprising:
forming a hole penetrating through the first insulating film and the adhesion enhancement layer;
embedding a metal in the hole; and
polishing the metal except the hole by chemical mechanical polishing method.
